(19) United States
(12) Patent Application Publication
(10) Pub. No.: US 2018/0179072 A1
(43) Pub. Date: Jun. 28, 2018

(54) SILICON MATERIAL AND METHOD FOR PRODUCING THE SAME

(71) Applicant: KABUSHIKI KAISHA TOYOTA JIDOSHOKKI, Kariya-shi, Aichi (JP)

(72) Inventors: Masanori HARATA, Kariya-shi (JP); Takashi MOHRI, Kariya-shi (JP); Nobuhiro GODA, Kariya-shi (JP)

(73) Assignee: KABUSHIKI KAISHA TOYOTA JIDOSHOKKI, Kariya-shi, Aichi (JP)

(21) Appl. No.: 15/735,227

(22) PCT Filed: May 20, 2016
(86) PCT No.: PCT/JP2016/002477

§ 371 Date: Dec. 11, 2017

(30) Foreign Application Priority Data
Jun. 12, 2015 (JP) 2015-119269

(51) Int. Cl. C01B 33/027; C01B 33/04; H01M 4/38; H01M 10/0525; H01G 11/86; H01G 11/30

(52) U.S. Cl. CPC C01B 33/027; C01B 33/04; H01M 4/386; C01P 2002/72; H01G 11/86; H01G 11/30; C01P 2006/40; H01M 10/0525

(57) ABSTRACT

Provided is a method for producing a silicon material, the method including: a molten metal preparing step of preparing Ca-x at % Si alloy (42≤x≤75) molten metal; a solidifying step of cooling the molten metal by a rapid cooling device to solidify the Ca-x at % Si alloy; a synthesizing step of reacting the solidified Ca-x at % Si alloy with acid to obtain a layered silicon compound; and a heating step of heating the layered silicon compound at not less than 300° C.

### TECHNICAL FIELD

The present invention relates to a silicon material and a method for producing the same.

### BACKGROUND ART

Silicon materials are known to be used as a constituent of a semiconductor, a solar battery, a secondary battery or the like, and studies on silicon materials are actively conducted in recent years.

For example, Non-Patent Literature 1 describes synthesizing layered polysilane by reacting CaSi₂ with acid.

Patent Literature 1 describes synthesizing layered polysilane by reacting CaSi₂ with acid, and describes that a lithium ion secondary battery having the layered polysilane as an active material exhibits a suitable capacitance.

Patent Literature 2 describes synthesizing a layered silicon compound of which main component is layered polysilane in which Ca is removed by reacting CaSi₂ with acid, and heating the layered silicon compound at not less than 300° C. to produce a silicon material from which hydrogen is removed, and also describes that a lithium ion secondary battery having the silicon material as an active material exhibits a suitable capacity retention rate.

### CITATION LIST

### Patent Literature

Patent Literature 1: JP2011090806 (A)
Patent Literature 2: WO2014/080608

### Non-Patent Literature

Non-Patent Literature 1: PHYSICAL REVIEW B, Volume 48, 1993, p. 8172-p. 8189

### SUMMARY OF INVENTION

### Technical Problem

As described above, studies on silicon materials are vigorously conducted. Silicon materials that are used as active materials of a secondary battery or the like are generally ground by a grinder into a size that is suited for use. The present inventors considered that the grinding operation of a silicon material by a grinder affects the silicon material in an adverse way.

The present invention was made in light of such circumstances, and aims at providing a production method that produces a silicon material having a desired size without the necessity of a grinding operation by a grinder.

### Solution to Problem

The silicon material is produced after converting CaSi₂ which is a starting material into a layered silicon compound which is a precursor. The inventors considered that the silicon material to be obtained become particulate by making the crystal particle size of CaSi₂ contained in the starting material small. Through diligent efforts made by the present inventors, the present inventors found that the crystal particle size of CaSi₂ contained in the starting material has a correlation with the particle diameter of the silicon material. On the basis of this finding, the present inventors accomplished the present invention.

A method for producing a silicon material of the present invention includes:

a molten metal preparing step of preparing Ca-x at % Si alloy (42≤x≤75) molten metal;

a solidifying step of cooling the molten metal by a rapid cooling device to solidify the Ca-x at % Si alloy;

a synthesizing step of reacting the solidified Ca-x at % Si alloy with acid to obtain a layered silicon compound; and a heating step of heating the layered silicon compound at not less than 300° C.

### Advantageous Effects of Invention

According to the method for producing a silicon material of the present invention, a silicon material having a desired size is produced without the necessity of a grinding operation by a grinder.

### BRIEF DESCRIPTION OF DRAWINGS

FIG. 1 is a powder X-ray diffraction chart showing a first solid of Comparative Example 1 and solidified CaSi₂ after grinding of Comparative Example 1;

FIG. 2 is an SEM image of solidified CaSi₂ of Example 1;

FIG. 3 is an SEM image of massive solidified CaSi₂ of Comparative Example 1;

FIG. 4 is an X-ray diffraction chart of solidified CaSi₂ of Example 2; and

FIG. 5 is an X-ray diffraction chart of a silicon material of Example 2.

### DESCRIPTION OF EMBODIMENTS

The following describes embodiments of the present invention. Unless mentioned otherwise in particular, a numerical value range of “x to y” described in the present specification includes, in a range thereof, a lower limit “x” and an upper limit “y”. A numerical value range is formed by arbitrarily combining such upper limit values, lower limit values, and numerical values described in Examples. In addition, numerical values arbitrarily selected within a numerical value range are used as upper limit and lower limit numerical values.

A method for producing a silicon material of the present invention includes:

a molten metal preparing step of preparing Ca-x at % Si alloy (42≤x≤75) molten metal;

a solidifying step of cooling the molten metal by a rapid cooling device to solidify the Ca-x at % Si alloy;

a synthesizing step of reacting the solidified Ca-x at % Si alloy with acid to obtain a layered silicon compound; and a heating step of heating the layered silicon compound at not less than 300° C.

In the following, a silicon material produced by the method for producing a silicon material of the present invention is also referred to as “silicon material of the present invention”.

First, the molten metal preparing step is described.

A Ca-x at % Si alloy means an alloy containing Ca and Si, wherein the element % of Si to a total number of elements of Ca and Si is x. The alloy may contain inevitable impurities, and may contain element M selected from elements of groups 3 to 9.

Element M is capable of forming MSiₐ (1/3≤a≤3) such as MSi₂ or MSi by binding with Si in the alloy. Since MSiₐ is capable of functioning as a buffer in expansion and contraction of the silicon material of the present invention, a secondary battery having the silicon material containing MSiₐ of the present invention as a negative electrode active material is considered to have excellent durability. Element M may be a single element or a plurality of elements selected from elements of groups 3 to 9. Preferred examples of element M include Ti, Zr, Hf, V, Nb, Ta, Cr, Mo, W, Sc, and Fe. The percentage of element M contained in the Ca-x at % Si alloy is preferably in a range of 0.01 to 10 mass %, more preferably in a range of 0.1 to 7 mass %, further preferably in a range of 1 to 5 mass %.

Examples of a specific method for preparing Ca-x at % Si alloy (42≤x≤75) molten metal include a method of heating CaSi₂ that is purchased or synthesized by a heater to obtain a molten metal, and a method of heating a mixture that is prepared by mixing a Ca source and a Si source in a molar ratio of about 1:4/3 to 1:3 by a heater to obtain a molten metal. Also, the Ca-x at % Si alloy (42≤x≤75) molten metal may be prepared by a method of preparing a Ca-containing molten metal at a relatively low temperature from a Ca source so as to prevent the loss due to scattering of Ca, and then putting a Si source into the Ca-containing molten metal to dissolve or decompose the Si source, or a method of putting a Ca source into a Si-containing molten metal. Examples of the heater that is used include a high-frequency induction heater, an electric furnace, and a gas furnace. The molten metal preparing step may be conducted under a pressurizing or reduced pressure condition, or may be conducted in an atmosphere of an inert gas such as argon.

The Ca source and the Si source may be respective simple substances, an alloy, or compounds respectively containing these elements. From the view point of obtaining a target substance with high purity, as the Ca source and the Si source, respective simple substances and/or a Ca—Si alloy are preferred.

As described above, since the Ca-x at % Si alloy may contain element M, the molten metal may be prepared by using an M source in addition to a Ca source and a Si source. The molten metal may be prepared by using a Ca source and/or a Si source preliminarily containing element M, or may be prepared by using CaSi₂ preliminarily containing element M.

Purchased CaSi₂ often contains impurities, and often fails to accurately satisfy the molar ratio between Ca and Si of 1:2. Usually, purchased CaSi₂ contains a larger amount of Si as compared with a theoretical value.

The melting point of the Ca-x at % Si alloy (42≤x≤75) is 1030 to 1300° C. according to the phase diagram, and the temperature of the molten metal is preferably higher by not less than 50° C. than the melting point in consideration of the handling after dissolution. On the other hand, if the molten metal temperature is too high compared with the melting point, the cooling efficiency is deteriorated, and the crystal particle size of the Ca-x at % Si alloy obtained after cooling tends to be large. Examples of the preferred molten metal temperature include the melting point +50 to +350° C., melting point +50 to +250° C., and melting point +50 to +150° C.

Next, the solidifying step of cooling the molten metal by using a rapid cooling device to solidify the Ca-x at % Si alloy (42≤x≤75) is described. The rapid cooling device described herein does not include a device that cools molten metal by leaving the molten metal to stand, but means a device that compulsorily cools molten metal. By rapidly cooling the molten metal with the rapid cooling device (for example, not less than 100° C./sec, preferably 1000° C./sec), CaSi₂ having a relatively small crystal particle size arises when the Ca-x at % Si alloy solidifies. The crystal particle size of CaSi₂ arising in the solidifying step determines the particle size of the aimed silicon material.

Examples of the range of the mean diameter of crystal particle size of CaSi₂ arising by the solidifying step include 0.1 to 100 μm, 0.1 to 50 μm, 0.1 to 20 μm, 0.5 to 15 μm, and 1 to 10 μm. The mean diameter of crystal particle size of CaSi₂ means a mean value of diameter determined by the following method.

1) Observe a section of the solidified Ca-x at % Si alloy under a scanning electron microscope (SEM).

2) In an SEM image, for every crystal particle of CaSi₂ of which entirety is observable, calculate an area of each crystal particle by using an EBSD (ElectronBackScatterDiffractionPatterns) method.

3) Calculate a diameter of each crystal particle assuming that each crystal particle is a perfect circle.

4) Calculate a mean value of the diameters.

When a cooling device using an atomizing method is employed as a rapid cooling device, the solidified Ca-x at % Si alloy is obtained in a powder form. At this time, each particle in a powder form is occasionally obtained as a single crystal. In such a case, as a mean diameter of crystal particle size of CaSi₂ arising in the solidifying step, a value of D50 measured by a general laser diffraction type particle size distribution measuring device may be employed.

Examples of the rapid cooling device include cooling devices equipped with cooling means that sprays molten metal on the rotating cooling roll (so-called a melt-spun method, a strip casting method, or a melt spinning method), or cooling means that employs an atomizing method wherein molten metal is pulverized, for example, by spraying a fluid to the molten metal in the form of a thin stream. Examples of the atomizing method include a gas atomizing method, a water atomizing method, a centrifugal atomizing method, and a plasma atomizing method. Concrete examples of the rapid cooling device include a liquid rapid solidifying device, a rapid cooling thin section producing device, a submerged spinning device, a gas atomizing device, a water atomizing device, a rotary disc device, a rotational electrode method device (these are available from NISSIN GIKEN Co., Ltd.), a liquid rapid cooling device, a gas atomizing device (these are available from MAKABE Technical Research Co., Ltd.), and a centrifugal powder producing device (Ducol Co., Ltd.).

As the rapid cooling device, a cooling device using an atomizing method that pulverizes the molten metal is preferred. The reason lies in that the Ca-x at % Si alloy is excellent in fluidity and is easy to handle because the Ca-x at % Si alloy is obtained in a powder form such as a globular form or an ellipsoidal form, and that the reaction time in the following synthesizing step is reduced because the alloy is obtained in a powder form.

For obtaining CaSi₂ having a smaller crystal particle size, the cooling speed in the solidifying step may be increased. Specifically, the methods of increasing the number of rotation of the cooling roll or the rotary disc, lowering the temperature of the cooling roll or the rotary disc, lowering the temperature of the cooling fluid, increasing the supply amount of the cooling fluid, or reducing the spraying amount of the molten metal per unit time or the flow amount of the molten metal may be employed.

The molten metal preparing step and the solidifying step as described above is also collectively referred to as a preparing step of preparing a Ca-x at % Si alloy (42≤x≤75) containing CaSi₂ crystal particles of a desired size.

Next, the synthesizing step of reacting the solidified Ca-x at % Si alloy with acid to obtain a layered silicon compound is described. In this step, in layered CaSi₂ constituting the Ca-x at % Si alloy, Si forms a Si—H bond while Ca is substituted by H of the acid. The layered silicon compound is in a layered form because the basic backbone of a Si layer by CaSi₂ constituting the Ca-x at % Si alloy which is a raw material is maintained.

Examples of the acid include hydrofluoric acid, hydrochloric acid, hydrobromic acid, hydroiodic acid, sulfuric acid, nitric acid, phosphoric acid, formic acid, acetic acid, methanesulfonic acid, tetrafluoroboric acid, hexafluorophosphoric acid, hexafluoroarsenic acid, fluoroantimonic acid, hexafluorosilicic acid, hexafluorogermanic acid, hexafluorostannic (IV) acid, trifluoroacetic acid, hexafluorotitanic acid, hexafluorozirconic acid, trifluoromethanesulfonic acid, and fluorosulfonic acid. These acids may be used singly or in combination.

In particular, use of an acid that causes a fluorine anion as the acid is occasionally preferred. By employing such acid, a Si—O bond and a bond between Si and anion of other acid (for example, Si—Cl bond in the case of hydrochloric acid) that possibly occur in the layered silicon compound are reduced. If a Si—O bond or a Si—Cl bond exists in the layered silicon compound, the Si—O bond or the Si—Cl bond occasionally exists in the silicon material even after the next step. In a lithium ion secondary battery in which a silicon material having a Si—O bond or a Si—Cl bond is used as a negative electrode active material, the Si—O bond or the Si—Cl bond is assumed to inhibit movement of lithium ions.

The acid used in the synthesizing step may be used in such an amount that supplies protons of not less than 2 equivalents to Ca of the Ca-x at % Si alloy. Therefore, a monovalent acid may be used in an amount of not less than 2 mols for 1 mol of Ca of the Ca-x at % Si alloy. While the step may be conducted in the absence of a solvent, use of water as a solvent is preferred from the view point of separation of the target substance and removal of a secondary product such as CaCl₂. As the reaction condition of the step, a reduced pressure condition such as in vacuum, or an inert gas atmosphere condition is preferred, and a temperature condition of not higher than room temperature such as in an ice bath is preferred. The reaction time of the step is appropriately set.

The chemical reaction of the synthesizing step in the case of using hydrochloric acid as acid for CaSi₂ which is one form of the Ca-x at % Si alloy is represented by the following ideal reaction formula.

3CaSi₂+6HCl*Si₆H₆+3CaCl₂

In the above reaction formula, Si₆H₆ corresponds to polysilane which is an ideal layered silicon compound.

The synthesizing step is preferably conducted in the presence of water, and Si₆H₆ reacts with water. Thus, normally, the layered silicon compound is rarely obtained as a compound of Si₆H₆ by itself, but contains oxygen or an element derived from acid.

Following the synthesizing step, preferably, a filtering step of collecting the layered silicon compound by filtration, a washing step of washing the layered silicon compound, and a drying step of drying the layered silicon compound are appropriately conducted if necessary.

Next, the heating step of heating the layered silicon compound at not less than 300° C. is described. In the step, the layered silicon compound is heated at not less than 300° C. to make hydrogen, water or the like leave, and thus a silicon material is obtained. An ideal reaction formula of the chemical reaction of this step is as follows.

Si₆H₆→6Si+3H₂←

Since the layered silicon compound that is actually used in the heating step contains oxygen or an element derived from acid, and further contains inevitable impurities, the silicon material that is actually obtained also contains oxygen or an element derived from acid, and further contains inevitable impurities.

Preferably, the heating step is conducted in a non-oxidative atmosphere containing less oxygen than under a normal atmosphere. Examples of the non-oxidative atmosphere include a reduced pressure atmosphere including vacuum, and an inert gas atmosphere. The heating temperature is preferably in a range of 350° C. to 1100° C., more preferably in a range of 400° C. to 1000° C. If the heating temperature is too low, removal of hydrogen is occasionally insufficient, whereas if the heating temperature is too high, the energy is wasted. The heating time is appropriately set in accordance with the heating temperature. Preferably, the heating time is determined while the amount of hydrogen coming off the reaction system is measured. By appropriately selecting the heating temperature and the heating time, the ratio between amorphous silicon and silicon crystallite contained in the silicon material to be produced, and the size of the silicon crystallite are adjusted. By appropriately selecting the heating temperature and the heating time, the form of the layer having a thickness in a nm order including amorphous silicon and silicon crystallite contained in the silicon material to be produced are adjusted.

As the size of the silicon crystallite, nm order is preferred. Specifically, the silicon crystallite size is preferably in a range of 0.5 nm to 300 nm, more preferably in a range of 1 nm to 100 nm, further preferably in a range of 1 nm to 50 nm, particularly preferably in a range of 1 nm to 10 nm. The silicon crystallite size is determined by subjecting the silicon material to an X-ray diffraction measurement (XRD measurement), and calculation by the Scherrer's equation using a half width of a diffraction peak in Si (111) plane of the obtained XRD chart.

By the heating step as described above, a silicon material having a structure made up of a plurality of plate-like silicon bodies laminated in the thickness direction is obtained. This structure is confirmed by observation with a scanning electron microscope or the like. In consideration of using the silicon material as an active material of a lithium ion secondary battery, the plate-like silicon body has a thickness preferably in a range of 10 nm to 100 nm, more preferably in a range of 20 nm to 50 nm for efficient insertion and elimination reaction of lithium ion. The plate-like silicon body has a length in the longitudinal direction preferably in a range of 0.1 μm to 50 μm. Regarding the plate-like silicon body, (length in the longitudinal direction)/(thickness) preferably falls in a range of 2 to 1000. The plate-like silicon body is preferably in such a condition that silicon crystallite is scattered in a matrix of amorphous silicon.

When the silicon material of the present invention contains element M, element M exists as MSiₐ (1/3≤a≤3). Specific examples of MSiₐ include TiSi₂, TiSi, ZrSi₂, HfSi₂, VSi₂, NbSi₂, TaSi₂, CrSi₂, CrSi_{1/3}, MoSi₂, MoSi_{1/3}, MoSi₃/s, WSi₂, FeSi₂, and FeSi. Examples of the shape of MSiₐ include a globular shape, an acicular shape, a plate-like shape, a disc shape, and an annular shape. In particular, when element M is Fe, annular FeSi₂ that covers the outer surface of the silicon material body is occasionally observed.

The silicon material of the present invention is obtained in a powder state without use of a special grinder. Even if a mass exists in the silicon material of the present invention, the mass is made into a powder state by application of light pressure. Therefore, cracks and strain that are deemed to occur in conventional powdery silicon materials due to use of a grinder are not observed in the silicon material of the present invention. Therefore, the silicon material of the present invention is considered to be excellent in durability against various uses.

Examples of a preferred range of mean particle diameter of the silicon material of the present invention include 1 to 100 μm, 1 to 50 μm, 1 to 20 μm, 1 to 15 μm, and 3 to 10 μm. The mean particle diameter of the silicon material of the present invention means D50 measured by a general laser diffraction type particle size distribution measuring device. Examples of the shape of the silicon material of the present invention include a globular shape and an ellipsoidal shape.

The silicon material of the present invention is used as a negative electrode active material of power storage devices including secondary batteries such as a lithium ion secondary battery, an electric double layer capacitor, and a lithium ion capacitor. The silicon material of the present invention is also used, for example, as materials for CMOS, semiconductor memory and solar battery, or as photocatalyst materials.

The lithium ion secondary battery of the present invention has the silicon material of the present invention as a negative electrode active material. Specifically, the lithium ion secondary battery of the present invention includes a positive electrode, a negative electrode having the silicon material of the present invention as a negative electrode active material, an electrolytic solution, and a separator.

The positive electrode has a current collector, and a positive electrode active material layer bound to the surface of the current collector.

The current collector refers to a fine electron conductor that is chemically inert for continuously sending a flow of current to the electrode during discharging or charging of the lithium ion secondary battery. Examples of the current collector include at least one selected from silver, copper, gold, aluminum, tungsten, cobalt, zinc, nickel, iron, platinum, tin, indium, titanium, ruthenium, tantalum, chromium, or molybdenum, and metal materials such as stainless steel. The current collector may be coated with a known protective layer. One obtained by treating the surface of the current collector with a known method may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, the thickness thereof is preferably in a range of 1 μm to 100 μm.

The positive electrode active material layer includes a positive electrode active material, and, if necessary, a conductive additive and/or a binding agent.

Examples of the positive electrode active material include layered compounds that are LiaNi_{b}CO_{c}Mn_{d}DₑO_{f} (0.2≤a≤2, b+c+d+e=1, 0≤e<1; D is at least one element selected from Li, Fe, Cr, Cu, Zn, Ca, Mg, S, Si, Na, K, Al, Zr, Ti, P, Ga, Ge, V, Mo, Nb, W, or La; 1.7≤f≤3) and Li₂MnO₃. Additional examples of the positive electrode active material include a spinel such as LiMn₂O₄, a solid solution formed from a mixture of a spinel and a layered compound, and polyanion-based compounds represented by LiMPO₄, LiMVO₄, Li₂MSiO₄ (where “M” is selected from at least one of Co, Ni, Mn, or Fe), or the like. Further additional examples of the positive electrode active material include tavorite-based compounds represented by LiMPO₄F (“M” is a transition metal) such as LiFePO₄F and borate-based compounds represented by LiMBO₃ (“M” is a transition metal) such as LiFeBO₃. Any metal oxide used as the positive electrode active material has a basic composition of the composition formulae described above, and those in which a metal element included in the basic composition is substituted with another metal element are also used as the positive electrode active material. In addition, as the positive electrode active material, a material for the positive electrode active material not containing lithium ion contributing to the charging and discharging, such as, for example, elemental substance sulfur, a compound that is a composite of sulfur and carbon, metal sulfides such as TiS₂, oxides such as V₂O₅ and MnO₂, polyaniline and anthraquinone and compounds containing such aromatics in the chemical structure, conjugate-based materials such as conjugate diacetic acid-based organic matters, and other known materials, may be used. Furthermore, a compound having a stable radical such as nitroxide, nitronyl nitroxide, galvinoxyl, and phenoxyl may be used as the positive electrode active material. When a material for the positive electrode active material not containing lithium is used, an ion has to be added in advance to the positive electrode and/or the negative electrode using a known method. For adding the ion, metal or a compound containing the ion may be used.

The conductive additive is added for increasing conductivity of the electrode. Thus, the conductive additive is preferably added optionally when conductivity of the electrode is insufficient, and may not be added when conductivity of the electrode is sufficiently good. As the conductive additive, a fine electron conductor that is chemically inert may be used, and examples thereof include carbonaceous fine particles such as carbon black, graphite, vapor grown carbon fiber (VGCF) and various metal particles. Examples of the carbon black include acetylene black, Ketchen black (registered trademark), furnace black, and channel black. These conductive additives may be added to the active material layer singly or in combination of two or more types of these conductive additives.

The blending ratio of the conductive additive in the active material layer in mass ratio, i.e., active material:conductive additive, is preferably 1:0.005 to 1:0.5, more preferably 1:0.01 to 1:0.2, further preferably 1:0.03 to 1:0.1. The reason is that if the conductive additive is too little, efficient conducting paths are not formed, whereas if the conductive additive is too much, moldability of the active material layer deteriorates and energy density of the electrode becomes low.

The binding agent serves to adhere the active material, the conductive additive or the like to the surface of the current collector, and maintain the conductive network in the electrode. Examples of the binding agent include a fluorine-containing resin such as polyvinylidene fluoride, polytetrafluoroethylene, or fluororubber, a thermoplastic resin such as polypropylene or polyethylene, an imide-based resin such as polyimide or polyamide-imide, an alkoxysilyl group-containing resin, an acrylic resin such as poly(meth)acrylic acid, styrene-butadiene rubber (SBR), carboxymethyl cellulose, an alginate such as sodium alginate or ammonium alginate, a water-soluble cellulose ester crosslinked product, and starch-acrylic acid graft polymer. These binding agents may be employed singly or in plurality.

The blending ratio of the binding agent in the active material layer in mass ratio: active material:binding agent, is preferably 1:0.001 to 1:0.3, more preferably 1:0.005 to 1:0.2, further preferably 1:0.01 to 1:0.15. The reason is that if the binding agent is too little, the moldability of the electrode deteriorates, whereas if the binding agent is too much, energy density of the electrode becomes low.

The negative electrode has a current collector, and a negative electrode active material layer bound to the surface of the current collector. Regarding the current collector, those described for the positive electrode may be appropriately and suitably employed. The negative electrode active material layer includes a negative electrode active material, and, if necessary, a conductive additive and/or a binding agent.

As the negative electrode active material, the silicon material of the present invention may be used, only the silicon material of the present invention may be used, or a combination of the silicon material of the present invention and a known negative electrode active material may be used. The silicon material of the present invention covered with carbon may be used as the negative electrode active material.

Regarding the conductive additive and the binding agent to be used in the negative electrode, those described for the positive electrode may be appropriately and suitably employed in the blending ratio as described above.

In order to form the active material layer on the surface of the current collector, the active material may be applied on the surface of the current collector using a known conventional method such as a roll coating method, a die coating method, a dip coating method, a doctor blade method, a spray coating method, and a curtain coating method. Specifically, an active material, a solvent, and if necessary, a binding agent and/or a conductive additive are mixed to prepare a slurry. Examples of the solvent include N-methyl-2-pyrrolidone, methanol, methyl isobutyl ketone, and water. The slurry is applied on the surface of the current collector, and then dried. In order to increase the electrode density, compression may be performed after drying.

The electrolytic solution contains a nonaqueous solvent and an electrolyte dissolved in the nonaqueous solvent.

Examples of the nonaqueous solvent include cyclic esters, linear esters, and ethers. Examples of the cyclic esters include ethylene carbonate, propylene carbonate, butylene carbonate, gamma butyrolactone, vinylene carbonate, 2-methyl-gamma butyrolactone, acetyl-gamma butyrolactone, and gamma valerolactone. Examples of the linear esters include dimethyl carbonate, diethyl carbonate, dibutyl carbonate, dipropyl carbonate, ethylmethyl carbonate, propionic acid alkyl esters, malonic acid dialkyl esters, and acetic acid alkyl esters. Examples of the ethers include tetrahydrofuran, 2-methyltetrahydrofuran, 1,4-dioxane, 1,2-dimethoxyethane, 1,2-diethoxyethane, and 1,2-dibutoxyethane. As a nonaqueous solvent, compounds in which part or all of hydrogens in the chemical structure of the specific solvents are substituted by fluorine may be employed.

Examples of the electrolyte include lithium salts such as LiClO₄, LiAsF₆, LiPF₆, LiBF₄, LiCF₃SO₃, and LiN(CF₃SO₂)₂.

Examples of the electrolytic solution include solutions prepared by dissolving a lithium salt such as LiClO₄, LiPF₆, LiBF₄, or LiCF₃SO₃ in a nonaqueous solvent such as ethylene carbonate, dimethyl carbonate, propylene carbonate, or diethyl carbonate in a concentration of about 0.5 mol/L to 1.7 mol/L.

The separator is for separating the positive electrode and the negative electrode to allow passage of lithium ions while preventing short circuit due to a contact of both electrodes. Examples of the separator include porous materials, nonwoven fabrics, and woven fabrics using one or more types of materials having electrical insulation property such as: synthetic resins such as polytetrafluoroethylene, polypropylene, polyethylene, polyimide, polyamide, polyaramide (aromatic polyamide), polyester, and polyacrylonitrile; polysaccharides such as cellulose and amylose; natural polymers such as fibroin, keratin, lignin, and suberin; and ceramics. In addition, the separator may have a multilayer structure.

Next, a method for producing a lithium ion secondary battery is described.

An electrode assembly is formed from the positive electrode, the negative electrode, and, if necessary, the separator interposed therebetween. The electrode assembly may be a laminated type obtained by stacking the positive electrode, the separator, and the negative electrode, or a wound type obtained by winding the positive electrode, the separator, and the negative electrode. The lithium ion secondary battery is preferably formed by respectively connecting, using current collecting leads or the like, the positive electrode current collector to a positive electrode external connection terminal and the negative electrode current collector to a negative electrode external connection terminal, and then adding the electrolytic solution to the electrode assembly. In addition, the lithium ion secondary battery of the present invention preferably executes charging and discharging in a voltage range suitable for the types of the active materials contained in the electrodes.

The form of the lithium ion secondary battery of the present invention is not limited in particular, and various forms such as a cylindrical type, a square type, a coin type, a laminated type, etc., are employed.

The lithium ion secondary battery of the present invention may be mounted on a vehicle. The vehicle may be a vehicle that uses, as all or a part of the source of power, electrical energy obtained from the lithium ion secondary battery, and examples thereof include electric vehicles and hybrid vehicles. When the lithium ion secondary battery is to be mounted on the vehicle, a plurality of the lithium ion secondary batteries may be connected in series to form an assembled battery. Other than the vehicles, examples of instruments on which the lithium ion secondary battery may be mounted include various home appliances, office instruments, and industrial instruments driven by a battery such as personal computers and portable communication devices. In addition, the lithium ion secondary battery of the present invention may be used as power storage devices and power smoothing devices for wind power generation, photovoltaic power generation, hydroelectric power generation, and other power systems, power supply sources for auxiliary machineries and/or power of ships, etc., power supply sources for auxiliary machineries and/or power of aircraft and spacecraft, etc., auxiliary power supply for vehicles that do not use electricity as a source of power, power supply for movable household robots, power supply for system backup, power supply for uninterruptible power supply devices, and power storage devices for temporarily storing power required for charging at charge stations for electric vehicles.

Although embodiments of the present invention have been described above, the present invention is not limited to the embodiments. Without departing from the gist of the present invention, the present invention is implemented in various modes with modifications and improvements, etc., that are made by a person skilled in the art.

### EXAMPLES

In the following, the present invention is specifically described by presenting Examples, Comparative Examples and so on.

The present invention is not limited to these Examples.

### Example 1

Solidified CaSi₂, a layered silicon compound, a silicon material and a lithium ion secondary battery of Example 1 were produced in the following manner.

Molten Metal Preparing Step

Ca and Si were weighed in a carbon crucible in a molar ratio of 1:2. The carbon crucible was heated at 1150° C. in an argon gas atmosphere by a high-frequency induction heating device, to obtain CaSi₂ molten metal.

Solidifying Step

The molten metal was cooled by a liquid rapid cooling solidification device (NISSIN GIKEN Co., LTD) to obtain solidified CaSi₂ of Example 1 in a thin strip form. The liquid rapid cooling solidification device (NISSIN GIKEN Co., LTD) is a device having cooling means that sprays molten metal on a rotating cooling roll.

Synthesizing Step

To 100 mL of a 36 mass % HCl aqueous solution in an ice bath, 10 g of the solidified CaSi₂ of Example 1 was added in an argon gas stream, and the mixture was stirred for 90 minutes. The reaction liquid was filtered, and the residue was washed with distilled water and acetone, and dried in a vacuum at room temperature for not less than 12 hours to obtain 8 g of a layered silicon compound. This product was used as a layered silicon compound of Example 1.

Heating Step

In an argon gas atmosphere, 8 g of the layered silicon compound of Example 1 was heated at 900° C. for 1 hour to obtain a silicon material of Example 1 in a powder form.

Production Step of Lithium Ion Secondary Battery

A slurry was prepared by mixing 45 parts by mass of the silicon material of Example 1 as the negative electrode active material, 40 parts by mass of graphite as the negative electrode active material, 10 parts by mass of polyamide imide as the binding agent, 5 parts by mass of acetylene black as the conductive additive, and an appropriate amount of N-methyl-2-pyrrolidone.

As the current collector, an electrolytic copper foil having a thickness of 20 μm was prepared. On the surface of the copper foil, the aforementioned slurry was applied in a film form by using a doctor blade. The copper foil on which the slurry was applied was dried for 20 minutes at 80° C. to remove N-methyl-2-pyrrolidone by volatilization, and thus a copper foil having a negative electrode active material layer formed on the surface of the foil was obtained. The copper foil was then compressed by using a roll pressing machine so that the thickness of the negative electrode active material layer was 20 μm to obtain a joined object. The obtained joined object was heated and dried for 2 hours in a vacuum at 200° C. to obtain an electrode.

The electrode was cut to have a diameter of 11 mm to obtain an evaluation electrode. A metal lithium foil was cut to have a diameter of 15 mm to obtain a counter electrode. As the separator, a glass filter (Hoechst Celanese) and Celgard 2400 (Polypore Inc.) which is a monolayer polypropylene were prepared. In a solvent prepared by mixing 50 parts by volume of ethylene carbonate, and 50 parts by volume of diethyl carbonate, LiPF₆ was dissolved in 1 mol/L to prepare an electrolytic solution. Two types of separators were sandwiched between the counter electrode and the evaluation electrode in the sequence of the counter electrode, the glass filter, Celgard 2400, and the evaluation electrode to obtain an electrode assembly. The electrode assembly was housed in a coin type battery case CR2032 (Hohsen Corp.), and further the electrolytic solution was injected, and thus a coin type battery was obtained. This was used as a lithium ion secondary battery of Example 1.

### Comparative Example 1

Solidified CaSi₂, a layered silicon compound, a silicon material and a lithium ion secondary battery of Comparative Example 1 were produced in the following manner.

Molten Metal Preparing Step

Ca and Si were weighed in a carbon crucible in a molar ratio of 1:2. The carbon crucible was heated at 1150° C. in an argon gas atmosphere by a high-frequency induction heating device, to obtain CaSi₂ molten metal.

Comparative Solidifying Step

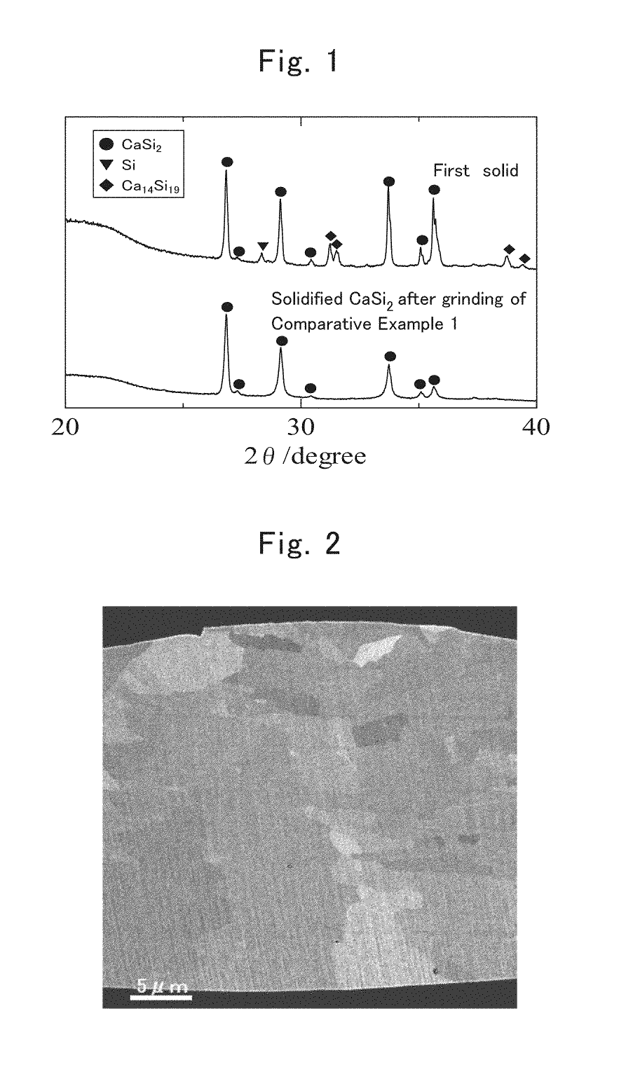

The molten metal was poured into a predetermined mold and cooled by leaving the molten metal to stand, and thus a first solid was obtained. The first solid contains impurities such as crystalline silicon and Ca₁₄Si₁₉. For reducing the amounts of these impurities, the first solid was heated at 900° C. for 12 hours in an argon gas atmosphere. Subsequently, the first solid was allowed to cool to obtain massive solidified CaSi₂ of Comparative Example 1. The massive solidified CaSi₂ was ground into powder in a mortar, and the powder was caused to pass through a sieve having an aperture of 53 μm. The powder having passed through the sieve was used as solidified CaSi₂ after grinding of Comparative Example 1. For reference, a powder X-ray diffraction chart of the first solid, and a powder X-ray diffraction chart of the solidified CaSi₂ after grinding of Comparative Example 1 are shown in FIG. 1.

Synthesizing Step

A layered silicon compound of Comparative Example 1 was obtained in the same manner as in Example 1 except that the solidified CaSi₂ after grinding of Comparative Example 1 was used.

Heating Step and Grinding Step

A silicon material was obtained by heating 8 g of the layered silicon compound of Comparative Example 1 at 900° C. for 1 hour in an argon gas atmosphere. The silicon material was ground by a jet mill, to obtain a silicon material of Comparative Example 1.

Lithium Ion Secondary Battery Producing Step

A lithium ion secondary battery of Comparative Example 1 was obtained in the same manner as in Example 1 except that the silicon material of Comparative Example 1 was used in place of the silicon material of Example 1.

### Evaluation Example 1

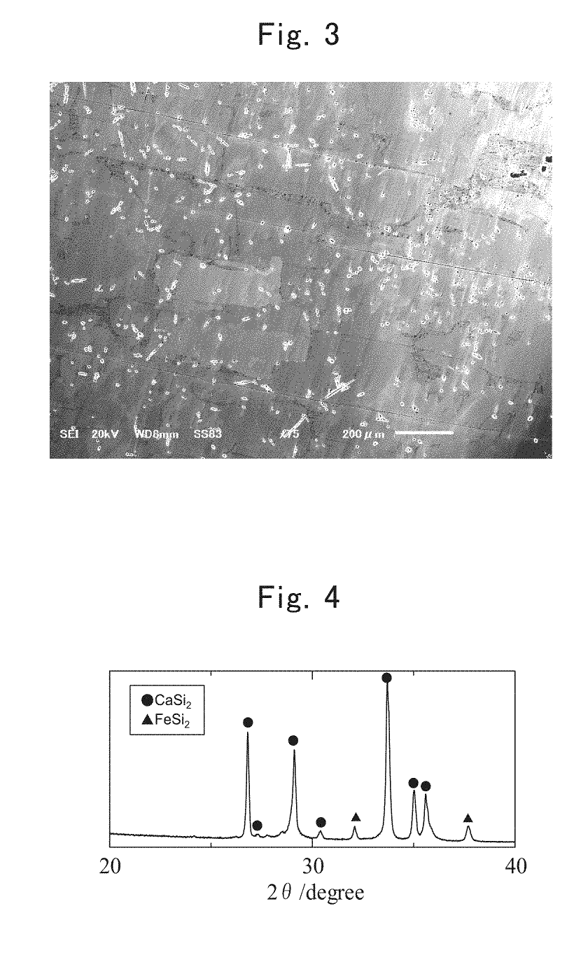

Sections of the solidified CaSi₂ of Example 1 and the massive solidified CaSi₂ of Comparative Example 1 were observed by SEM. An SEM image of the solidified CaSi₂ of Example 1 is shown in FIG. 2, and an SEM image of the massive solidified CaSi₂ of Comparative Example 1 is shown in FIG. 3. Further, in the SEM image in FIG. 2, for every crystal particle in which the entirety of the crystal particle of CaSi₂ was observed, an area of each crystal particle was calculated by using the EBSD method, a diameter of each crystal particle assuming that each crystal particle was a perfect circle was calculated, and a mean value of the calculated diameters was calculated. The resultant mean value was 3.42 μm. This value was used as a mean diameter of crystal particle size of CaSi₂ of Example 1.

Since a large number of pores were observed in the SEM image of the massive solidified CaSi₂ of Comparative Example 1, the area of each crystal particle could not be calculated by using the EBSD method. Comparison between the SEMs in FIG. 2 and FIG. 3 clearly revealed that the crystal particle of the massive solidified CaSi₂ of Comparative Example 1 is significantly large, and has a diameter of approximately 200 μm.

### Evaluation Example 2

Using a laser diffraction type particle size distribution measuring device, particle size distributions of the silicon materials of Example 1 and Comparative Example 1 were measured, and respective values of D50 were calculated. The result is shown in Table 1.

TABLE 1

| | Mean diameter of crystal | |
|---|---|---|
| | particle of CaSi₂ | D50 of silicon material |
| Example 1 | 3.42 μm | 6.2 μm |
| Comparative | about 200 μm | 5.2 μm (after jet mill |
| Example 1 | | grinding) |

D50 of the silicon material of Example 1 is considered to be on the equivalent level to the size of the mean diameter of the crystal particle of the solidified CaSi₂ of Example 1. Thus, the method for producing the silicon material of the present invention is confirmed to produce a silicon material having a suitable size without the necessity of a grinding operation by a grinder.

### Evaluation Example 3

For the lithium ion secondary batteries of Example 1 and Comparative Example 1, 30 cycles of a charging and discharging cycle were conducted. Each charging and discharging cycle included discharging conducted at 0.25 C rate until the voltage of the evaluation electrode relative to the counter electrode was 0.01 V, and charging conducted at 0.25 C rate until the voltage of the evaluation electrode relative to the counter electrode was 1 V. (Charge capacity at the 30th cycle/charge capacity of the first time)×100 was calculated as capacity retention rate (%). The result is shown in Table 2.

In Evaluation example 3, occluding Li in the evaluation electrode is called discharging, and releasing Li from the evaluation electrode is called charging.

TABLE 2

| | Capacity retention rate (%) |
|---|---|
| Example 1 | 87.8% |
| Comparative Example 1 | 82.6% |

The capacity retention rate of the lithium ion secondary battery of Example 1 was superior to the capacity retention rate of the lithium ion secondary battery of Comparative Example 1. This result implies that the life of the lithium ion secondary battery having the silicon material of Comparative Example 1 was short because in the silicon material which was used in the lithium ion secondary battery of Comparative Example 1, cracks or strain due to jet mill grinding occurred, whereas the life of the lithium ion secondary battery having the silicon material of Example 1 was long because in the silicon material which was used in the lithium ion secondary battery of Example 1, significant cracks or strain did not occur.

The fact that the silicon material of the present invention is suitable was confirmed.

### Example 2

Solidified CaSi₂, a layered silicon compound, a silicon material and a lithium ion secondary battery of Example 2 were produced in the following manner.

Molten Metal Preparing Step

In a carbon crucible, 10 parts by mass of CaSi₂ containing 3.8 mass % of Fe and 1 part by mass of Ca were weighed. The carbon crucible was heated at 1150° C. in an argon gas atmosphere by a high-frequency induction heating device, to obtain Fe-containing CaSi₂ molten metal. The composition formula of Ca, Fe and Si in the Fe-containing CaSi₂ molten metal is Ca_{1.08}Fe_{0.08}Si_{1.9}.

Solidifying Step

The molten metal was cooled by a centrifugal powder producing device (Ducol Co., Ltd.) to obtain solidified CaSi₂ of Example 2 in the form of globular powder. The centrifugal powder producing device (Ducol Co., Ltd.) is a device that cools the molten metal in the form of liquid droplets and produces powder by scattering the molten metal in liquid droplet forms by flowing down the molten metal onto the rotating disc, and corresponds to a cooling device utilizing a centrifugal atomizing method.

Synthesizing Step, Heating Step and Lithium Ion Secondary Battery Producing Step

A layered silicon compound, a silicon material and a lithium ion secondary battery of Example 2 were produced in the same manner as in Example 1 except that the solidified CaSi₂ of Example 2 was used.

### Comparative Example 2

Solidified CaSi₂, a layered silicon compound, a silicon material and a lithium ion secondary battery of Comparative Example 2 were produced in the following manner.

Molten Metal Preparing Step

Fe-containing CaSi₂ molten metal was produced in the same manner as in Example 2.

Comparative Solidifying Step

The molten metal was poured into a predetermined mold and cooled by leaving the molten metal to stand, and thus massive solidified CaSi₂ was obtained. The massive solidified CaSi₂ was ground into a powder in a mortar, and the powder was caused to pass through a sieve having an aperture of 53 μm. The powder having passed through the sieve was used as solidified CaSi₂ after grinding of Comparative Example 2.

Synthesizing Step, Heating Step and Lithium Ion Secondary Battery Producing Step

A layered silicon compound, a silicon material and a lithium ion secondary battery of Comparative Example 2 were produced in the same manner as in Example 2 except that the solidified CaSi₂ after grinding of Comparative Example 2 was used.

### Evaluation Example 4

Using a laser diffraction type particle size distribution measuring device, particle size distributions of the solidified CaSi₂ of Example 2 and the silicon materials of Example 2 and Comparative Example 2 were measured, and respective values of D50 were calculated. The result is shown in Table 3.

TABLE 3

| | D50 of crystal particle of | |
|---|---|---|
| | CaSi₂ | D50 of silicon material |
| Example 2 | 87 μm | 72 μm |
| Comparative | Unmeasured, but passed | 19 μm |
| Example 2 | through a sieve having an | |
| | aperture of 53 μm after | |
| | grinding in a mortar | |

D50 of the silicon material of Example 2 is considered to be on the equivalent level to D50 of crystal particle of the solidified CaSi₂ of Example 2. Particles of the solidified CaSi₂ of Example 2 were confirmed to be monocrystalline. Thus, the method for producing the silicon material of the present invention is confirmed to produce a silicon material having a suitable size without the necessity of a grinding operation.

### Evaluation Example 5

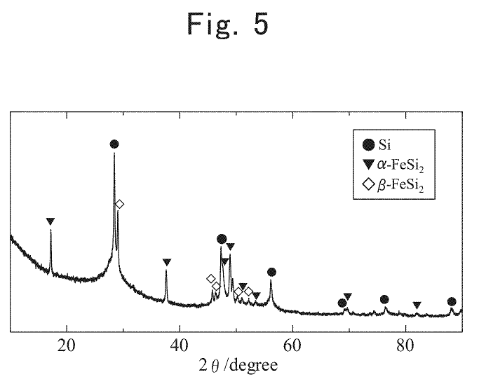

Using a powder X-ray diffraction device, the solidified CaSi₂ and the silicon material of Example 2 were analyzed. The obtained X-ray diffraction charts are shown in FIG. 4 and FIG. 5. FIG. 4 supports the existence of CaSi₂ and FeSi₂ in the solidified CaSi₂ of Example 2. FIG. 5 supports the existence of Si and FeSi₂ in the silicon material of Example 2.

### Evaluation Example 6

The silicon material of Example 2 was analyzed by SEM and SEM-EDX (energy dispersive X-ray analysis). The analysis revealed that the silicon material of Example 2 is formed of a Si-based silicon material main body in an ellipsoidal form, and circular FeSi₂ that covers the vicinity of the circumference at the minor axis in the ellipsoid of the main body.

### Evaluation Example 7

The lithium ion secondary batteries of Example 2 and Comparative Example 2 were evaluated in the same manner as Evaluation example 3. The result is shown in Table 4.

TABLE 4

| | Capacity retention rate (%) |
|---|---|
| Example 2 | 79.8% |
| Comparative Example 2 | 68.2% |

The capacity retention rate of the lithium ion secondary battery of Example 2 was superior to the capacity retention rate of the lithium ion secondary battery of Comparative Example 2. This result implies that the life of the lithium ion secondary battery having the silicon material of Comparative Example 2 was short because in the silicon material which was used in the lithium ion secondary battery of Comparative Example 2, an adverse effect due to grinding occurred for the solidified CaSi₂ in the comparative solidifying step, whereas the life of the lithium ion secondary battery having the silicon material of Example 2 was long because in the silicon material which was used in the lithium ion secondary battery of Example 2, significant cracks or strain did not occur.

1-6. (canceled)

7. A method for producing a silicon material, the method comprising:
a molten metal preparing step of preparing Ca-x at % Si alloy (42≤x≤75) molten metal;
a solidifying step of cooling the molten metal by a rapid cooling device to solidify the Ca-x at % Si alloy;
a synthesizing step of reacting the Ca-x at % Si alloy with acid to obtain a layered silicon compound, the Ca-x at % Si alloy having been solidified without performing grinding by a grinder; and
a heating step of heating the layered silicon compound at not less than 300° C.

8. The method for producing a silicon material according to claim 7, wherein the rapid cooling device is selected from a cooling device that uses a cooling means of spraying the molten metal on a rotating cooling roll, or a cooling device that uses an atomizing method.

9. The method for producing a silicon material according to claim 7, wherein the rapid cooling device is selected from a liquid rapid solidifying device, a rapid cooling thin section producing device, a submerged spinning device, a gas atomizing device, a water atomizing device, a rotary disc device, a rotational electrode method device, or a centrifugal powder producing device.

10. A method for producing a silicon material, the method comprising:
a preparing step of preparing a Ca-x at % Si alloy (42≤x≤75) containing CaSi₂ crystal particles having a mean diameter of 0.1 to 100 μm, without performing grinding by a grinder;
a synthesizing step of reacting the Ca-x at % Si alloy with acid to obtain a layered silicon compound; and
a heating step of heating the layered silicon compound at not less than 300° C.

11. The method for producing a silicon material according to claim 10, wherein the preparing step is the molten metal preparing step of preparing Ca-x at % Si alloy (42≤x≤75) molten metal and a solidifying step of cooling the molten metal by a rapid cooling device to solidify the Ca-x at % Si alloy.

12. A method for producing a secondary battery, the method comprising the step of producing a secondary battery using a silicon material that is produced by the method for producing a silicon material according to claim 7.
